(19) United States
(12) Patent Application Publication
(10) Pub. No.: US 2006/0151387 A1
(43) Pub. Date: Jul. 13, 2006

(54) Multiple soil-layering system for wastewater purification

(76) Inventors: Russell Yost, Honolulu, HI (US); Tsugiyuki Masunaga, Matsue (JP); Toshiyuki Wakatsuki, Nara (JP); Guy Porter, Kaneohe, HI (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/296,653

(22) Filed: Dec. 6, 2005

Related U.S. Application Data
(60) Provisional application No. 60/633,964, filed on Dec. 6, 2004.

(51) Int. Cl. C02F 3/30

(52) U.S. Cl. 210/605; 210/617; 210/630

(57) ABSTRACT

A water purification system having multiple soil layers is disclosed. The system has at least two aerobic soil layers with an anaerobic soil layer positioned between the aerobic layers. Water passing through the system can pass in sequence from an aerobic layer, to an anaerobic layer, then to another aerobic layer, and so forth. The system can also include a water inlet, a water outlet, and an air distributor in at least one soil layer.

### CROSS-REFERENCE TO RELATED APPLICATIONS

This application claims priority under 35 U.S.C. §119 to U.S. Provisional Application No. 60/633,964, filed Dec. 6, 2004, the disclosure of which is hereby incorporated by reference in its entirety.

### STATEMENT REGARDING FEDERALLY SPONSORED R&D

Certain aspects of the invention disclosed herein were made with United States government support under USDA (U.S. Department of Agriculture) T-Star Project, Award No. 2003-34135-14033. The United States government has certain rights in these aspects of the invention.

### BACKGROUND OF THE INVENTION

1. Field of the Invention

The present invention relates to systems and methods of treating wastewater by passage through multiple layers of soil. In preferred embodiments, the layers alternate between aerobic and anaerobic environments. The system provides a cost-effective combination of mechanical filtration with chemical and biological treatment of wastewater.

2. Description of the Related Art

The environmental impact of untreated wastewater is a significant problem plaguing society today. Wastewater contains a variety of pollutants such as nitrogenous wastes, phosphorus and sulfur-containing compounds, fecal coliform, other organic chemicals, and heavy metals. These pollutants may come from various sources such as, for example, sewage plants, industrial plants, mines, farms, and dairies. Inadvertent discharge of wastewater can lead to public health epidemics such as infectious diarrhea, hepatitis, heavy metal poisoning, and the like, when drinking water becomes contaminated. Furthermore, fish and other members of aquatic ecosystems can be adversely affected when streams, lakes, rivers, and ponds, are contaminated by wastewater. Moreover, agricultural products, wildlife, livestock, and the like can be detrimentally affected from contaminated runoff, ground, or surface water contamination. The aforementioned effects can lead to a number of significant health, economic, and environmental consequences. Various wastewater purification systems employed to combat or prevent the above problems can cost billions of dollars annually.

Purification of wastewater typically involves one or more of mechanical, chemical, and biological processes; each have various advantages as well as limitations. Mechanical processes often involve techniques such as sedimentation, flocculation, filtration, reverse osmosis, adsorption, and air or steam stripping. Current mechanical systems are effective at capturing large or suspended particles, but are less effective at eliminating small or dissolved particles, soluble toxins and organic materials, and infectious biological agents. Furthermore, such systems often have high energy demands and require significant maintenance.

Chemical processes, include reduction, oxidation, pH changes, and other processes, including the use of catalysts, and may cause precipitation, coagulation, and modification of toxic chemicals to less harmful compounds, or facilitate their destruction. One example of a chemical process is the conversion of toxic cyanides into carbon dioxide and nitrogen via oxidation with chlorine. While chemical processes are not effective for removal of larger particles, they are advantageous in isolating out smaller, more soluble wastewater components that mechanical processes cannot.

Biological processes interact with, destroy, or consume various wastewater components, by the use of aerobic and/or anaerobic microorganisms. A biological process can, for example, convert toxic ammonia into nitrates by way of aerobic organisms, and nitrates to harmless nitrogen gas via anaerobic organisms. There are two major types of biological processes, attached growth and suspended growth processes. Attached growth processes may include trickling filters, biotowers or rotating biological contacters, where the wastewater is distributed over microorganisms growing on rocks, plastic media, or rotating discs; suspended growth processes often involve a mixed microbial sludge in a tank in which wastewater may enter, such as in an activated sludge system. Biological processes are thus very useful in eliminating nitrogenous or phosphorus-containing wastes (that may, for example cause nuisance growth of algae in the end-purified water). However, one problem associated with such biological processes is that the microorganisms utilized can overproliferate and cause undesirable biofilms (biomass) that clog up wastewater purification system components.

### SUMMARY OF THE INVENTION

What is needed in the field of wastewater treatment is a simple, compact, efficient, cost-effective, low-maintenance system that will substantially purify contaminated wastewater. Such a system will optimally use a combination of mechanical, chemical, and biologic processes while minimizing potential disadvantages traditionally associated with those processes. Such a system would also ideally generate beneficial renewable resource components from the wastewater such as fertilizer, or product water that may be used for agricultural irrigation.

In some embodiments of the present invention, a water purification system is provided, having at least two aerobic soil layers with an anaerobic soil layer positioned between them, where at least a portion of the water passing through the system can pass in sequence from an aerobic layer, to an anaerobic layer, then to another aerobic layer. The system can also have a water inlet, a water outlet, and an air distributor in at least one soil layer. The system can have, for example, at least two each of aerobic layers and anaerobic layers in an alternating order. The soil layers can be positioned, for example, substantially horizontally, such that at least one anaerobic layer has an aerobic layer above it and an aerobic layer beneath it. The system can have, for example, at least about 6 aerobic layers and at least about 5 anaerobic layers. The system can have, for example, an air distributor comprising an aeration pipe positioned in an aerobic soil layer. The aeration pipe can be positioned, for example, in a layer that is closer to a lower boundary of the system than to an upper boundary of the system. The anaerobic layer can have anaerobic soil material with portions of aerobic soil material positioned therein, so that the system has a substantially continuous aerobic pathway through the plurality of soil layers. The aerobic pathway can be non-linear. The aerobic layer can have, for example, at least one component selected from zeolite, perlite, and soil. The anaerobic layer can have, for example, at least one component selected from soil, metal iron, organic matter, and charcoal.

In an additional embodiment of the present invention, a method of water purification is provided, having a layered soil system with a series of alternating aerobic and anaerobic soil layers, an air distributor, a water inlet and a water outlet, by introducing contaminated water at the inlet, where the contaminated water comprises a first amount of at least one contaminant, aerating the system by introducing a gas having oxygen into the air distributor, and recovering purified water from the outlet, where the purified water has a second amount of at least one contaminant, and where the second amount is lower than the first amount. The contaminated water can have, for example, at least one contaminant selected from biological oxygen demand organic matter, chemical oxygen demand organic matter, nitrogen, phosphorus, a microorganism, an endocrine disrupter, a pesticide, a hormone, or a heavy metal. The microorganism can be, for example, a fecal coliform bacterium. The contaminated water can be derived, for example, a source selected from an animal facility, a municipality, a building, a river, a lake, dairy waste, agricultural effluent, pond, crop effluent, sewage facility, slough, waste from crop plants, drainage from industrial facilities, aquaculture waste, food production waste, or overflow runoff.

In a further embodiment of the present invention, a method of assembling a water purification system is provided, by positioning a plurality of soil layers to form a stack of alternating aerobic and anaerobic soil layers, providing a water inlet capable of directing water to or above an upper layer, and providing a water outlet capable of carrying water from or below a lower layer. The method can also have, for example, an air distributor in at least one layer. The air distributor can have, for example, an aeration pipe having a plurality of holes therein. The positioning step can involve, for example, placing layers of anaerobic material where, in each layer, the anaerobic material is interrupted with regions of aerobic material such that the assembled system has a continuous vertical pathway of aerobic material, the pathway having the aerobic layers in contact with aerobic portions positioned within the anaerobic layers. The vertical aerobic pathway can be non-linear. The positioning step can involve, for example, positioning at least about 6 aerobic layers and at least about 5 anaerobic layers.

### BRIEF DESCRIPTION OF THE DRAWINGS

FIG. 1 is an elevated view of certain structural components of an exemplary the soil layering system.

FIG. 2 is a cross-sectional view of an exemplary soil layering system.

FIG. 3 is a cross-sectional view of an exemplary soil layering system adapted for swine effluent.

FIG. 4 is a depiction of various arrangements of blocks of anaerobic material in a soil layering system.

### DETAILED DESCRIPTION OF THE PREFERRED EMBODIMENT

Certain embodiments of the invention provide a water purification system capable of substantially purifying contaminated water. The source of water can be water from a dairy, swine yard, or other animal facility; likewise, the source of water can be from a municipality, a sewage treatment system, a building or subdivision, a campground and the like; further, the source of water can also be a river, a lake, a ditch, a bog, and the like. Preferred embodiments of the system are characterized by having an alternating series of layers of soil. The alternating series of layers includes anaerobic layers positioned between aerobic layers. The series of layers, stacked vertically, provide a simple yet very effective combination of water purification features usually only found in much more complex systems.

Wastewater purification typically involves mechanical, chemical, and biological processes. The mechanical processes capture larger particles from the feed stream, while permitting passage of water and dissolved materials and smaller particles. Chemical processes include reduction, oxidation, pH changes, and other processes that can react with, degrade, destroy, and/or modify the solubility of certain chemical compounds. Biological processes include functions of microorganisms that result in destruction, consumption, and/or sequestration of any of a large variety of contaminants. As an example of the biological process, microorganisms in the aerobic layer can convert the major nitrogen-containing contaminant, ammonia, to nitrate, and the nitrate then can be transformed in the anaerobic layer into nitrogen gas. Thus, the system provides a very simple means for removal of nitrogen from a high-nitrogen feed stream. As an example of the chemical process, phosphorus is removed as follows: in the anaerobic layer, the lack of oxygen solubilizes existing iron which flows from the anaerobic layer into the adjacent aerobic layer. In the aerobic layer, the iron is oxidized and precipitates, which forms a very adsorptive layer for the phosphorus. Thus, the phosphorus is retained in the aerobic layer and is removed from the water being treated. Thus, the soil layering system disclosed herein provides a combination of mechanical separation, chemical reactions including prominently redox reactions, and a series of biological processes, which together provide a means for removing and/or modifying the major contaminants in a typical source of wastewater.

A key factor of the soil characteristics in the different layers is porosity. A highly porous soil or other material permits entry and circulation of air, which results in relatively high oxygen content in such a layer. In contrast, the anaerobic layer is characterized by low porosity and may also include high content of organic carbon. In addition, the anaerobic layer is preferably spiked with iron filings. The iron dissolves under anaerobic conditions and participates in the reaction with phosphorus that results in the capture of phosphorus in the aerobic layers. In preferred embodiments, the system permits removal of at least about 90% of nitrogen and phosphorus and also effectively removes other contaminants depending upon their chemical and physical characteristics.

The flow rate of the system and the residence time of the contaminated water in the system can be adjusted by the dimensions and the number of layers in the stack. It can also be adjusted by the porosity of the aerobic layers, according to the needs and characteristics of a particular type of wastewater. Thus, for a situation in which a longer residence time is desirable, such can be achieved by reducing the overall porosity of the system, reducing the overall dead space or open space within the system, and/or by increasing or decreasing the number of layers in the system and the total height of the stack of layers.

Structurally, the system typically includes a bottom layer of gravel or other highly porous material below or within which can be placed a collection system, pan, pipes, and the like. This bottom portion of the system is preferably sealed with plastic, metal, or other materials, in order to avoid loss of purified water by further vertical descent into the soil or other material below the stack. A layer above the drainage layer can either be an aerobic layer or an anaerobic layer. Typically, the bottom-most soil layer is aerobic. In preferred embodiments, the anaerobic layer is positioned by placing discrete, discontinuous blocks of anaerobic material on top of the aerobic layer. Spaces between the blocks or channels within an otherwise continuous layer of anaerobic material are filled with aerobic material up to the level of the anaerobic material in the layer. Thus, if viewed from above, the anaerobic layer can be seen as having a pattern of anaerobic and aerobic portions of material. A benefit of the regions of aerobic material within the anaerobic layer is to permit a continuous pathway of aerobic material throughout the height of the stack of layers. This pathway avoids clogging and slows the formation of biofilms in the system. In addition, the aerobic pathways permit efficient delivery of oxygen throughout the system even in embodiments in which air is delivered to the system only in one layer.

In preferred embodiments, the system includes an air distributor positioned in at least one aerobic layer. In preferred embodiments, the air distribution is positioned in a lower aerobic layer, at or below the midline of the height of the stack. Air, oxygen, or other combinations of gases carrying oxygen, can be pumped into the system via the air distributor, resulting in the delivery of oxygen to substantially all of the aerobic material within the stack. The air distribution is typically a single pipe or a branched combination of pipes wherein the pipe or pipes have a series of holes permitting distribution and passage of air throughout the length of the pipe.

The water collection layer at the bottom of the stack can include a single pipe or a branched series of pipes with holes permitting influx of water into the piping system and collection of water therein to be recovered as purified water. Further, the system can include a water inlet which in preferred embodiments includes a water distribution structure which, again, can be a branched series of pipes with holes therein permitting substantially uniform distribution of water across the upper surface area of the top layer in the system. Optionally, the top layer of the system, including the water distribution, can be overlaid with gravel, additional soil, plastic sheeting, or any other material if it is desirable to diminish escape of fumes or mixing of the wastewater entering the system with other materials such as, for example, rainwater.

The capacity of the system to purify water with very little maintenance is typically as long as 10 years. One factor that can limit the capacity or lifespan of the system is the availability of iron. However, this can be adjusted by spiking the anaerobic layers with iron filings and/or use of a high-iron soil in the anaerobic layers.

The positions of the regions of aerobic material within the anaerobic layers is typically staggered from one anaerobic layer to the next. This has the effect of avoiding formation of any particular straight line pathway for water to flow that would entirely miss any contact with anaerobic material. Water passing only through aerobic material would miss the water-purification functions of the anaerobic layer. Water flow through the system is substantially along a straight line downward, while the non-straight-line pathways of the continuous network of aerobic material accomplishes the benefit of distributing air throughout the system without providing an alternate pathway for water to avoid the repeating layers of aerobic and anaerobic material. Likewise, the continuous network of porous aerobic material permits the venting of nitrogen gas that is formed in the anaerobic layers.

The stack of layers can be of any suitable height. The stack can be, for example, less than about 1 meter to more than about 10 meters in height. In preferred embodiments, a stack of layers is typically 1.5 to 2 meters in height. The system is highly scalable, permitting adjustment of total surface area in the system to accommodate for a desired overall flow volume through the system and a desirable residence time within the system. Adjustments of these parameters can permit adaptation of the system for only moderately contaminated water or highly contaminated water, for example. In addition, these adaptations can be made to accommodate high capacity needs or lower capacity needs, as dictated by the circumstances.

In preferred embodiments, the multiple soil layering system water purification arrangement is deployed in pairs of stacks. The pairs of stacks permit water to be directed to one member of a pair at any given time. It has been found that biologically oriented purification systems, particularly with those with variable porosity, can promote the formation of biofilms which can inhibit flow or can in some cases entirely block flow through the system. However, biofilms, whose growth is favored by anaerobic conditions, are themselves attacked and degraded under aerobic conditions. Accordingly, when an abnormally low flow rate through a system indicates likely presence of a biofilm, the water can be directed to the other member of the pair, permitting the clogged system to become sufficiently aerobic for the biofilm to be broken down.

Energy requirements for the system are minimal, and are related to the cost of pumping influent into the system, effluent from the system, and air into the system. It should be noted that in many configurations, gravity alone can obviate the need for any pumping of water. Likewise, the amount of flow through the system, and the overall porosity in the system can reduce or in some cases eliminate the need for pump-driven aeration of the system. Aeration is therefore an optional control aspect of the system. Adjustable aeration can permit adjustment of the balance between the anaerobic and the aerobic conditions. In some embodiments, aeration is adjusted dynamically based upon parameters of the inlet and outlet water.

The multi-soil layering system has the advantages of simultaneous reduction of organic pollutants including biological oxygen demand and chemical oxygen demand (BOD/COD), nitrogen, phosphorus, and fecal coliform from wastewater. Another advantage is that the system can be built locally from easily available resources in almost any location. Further, the system can treat discharge of highly contaminated water resulting in product water that may be usable for agricultural irrigation. Additional contaminants may be present in wastewater and that can be sequestered, modified, or destroyed include: endocrine disruptors, such as estrogen, pesticides, other animal hormones, antibiotics, and other chemicals.

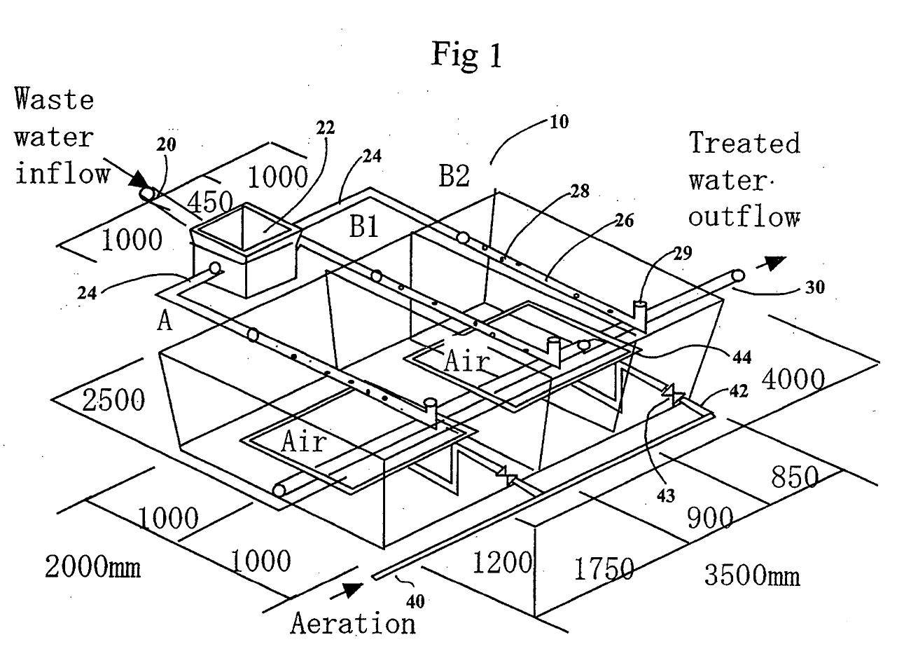

FIG. 1 depicts a view of a particular embodiment of the system. In the system 10 water flows through a wastewater inlet 20 into a collection basin 22. From the collection basin 22 water is distribution through inlet branches 24 to inlet distribution pipes 26. The inlet distribution pipes 26 include a series of inlet holes 28 spaced along their length, permitting water to flow out of the inlet distribution pipes 26 downward into the soil layers below. Additional structures within the system that are depicted in FIG. 1 include, at the bottom of the system, a product water outlet pipe 30. Water exits the system through this pipe 30 by entering holes in the pipe (not shown). Positioned at a height that is intermediate in the system between the wastewater inlet 20 and the product water outlet 30 is an aeration system including an aeration pipe 40, aeration branches 42, aeration valves 43 and aeration manifolds 44. Air passes into the aeration pipe 40 and is distributed via the aeration branches 42 to the aeration manifolds 44 within the soil layer. Adjustment of airflow can be achieved by adjustment of the aeration valves 43, such that airflow can be modified according to the needs and the output and input parameters of the system.

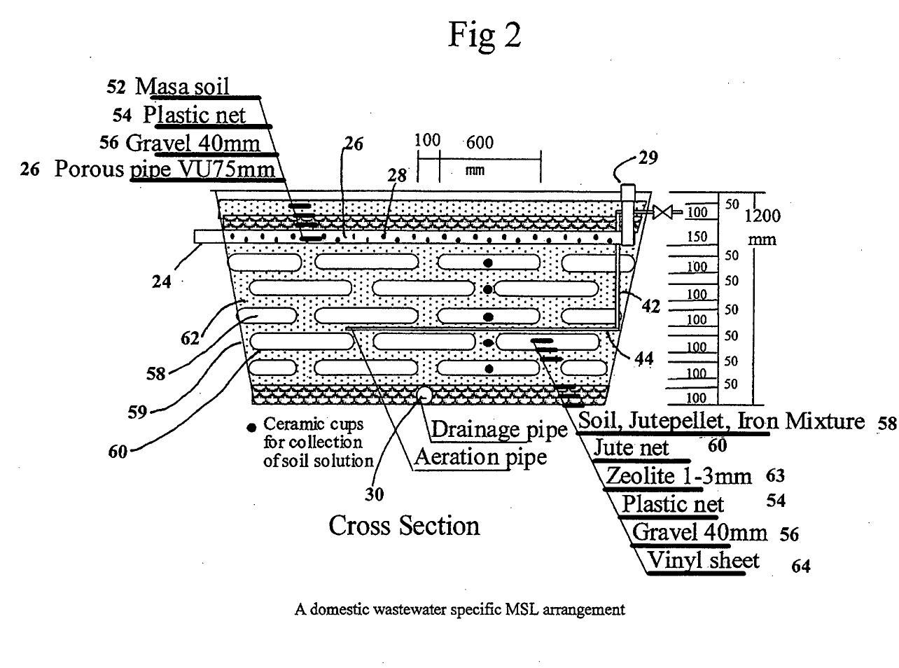

With reference to FIG. 2, the system 10 is depicted in cross section. Construction of the system 10 begins with laying a vinyl sheet 64 at the bottom of a container or a hole that has been excavated for purposes of accommodating the system 10, or upon whatever surface the system will rest. Above the vinyl sheet 64 is placed the product water outlet 30; around the product water outlet 30 is placed a layer of gravel 56. The gravel 56 permits drainage of water into the layer below the lowermost soil layer, and the water can enter the product water outlet 30 and exit the system therethrough. Above the gravel layer 56 is a plastic net 54 upon which are placed, alternately, layers of aerobic material 63 and anaerobic material 58. The aerobic material 63 is preferably zeolite 1-3 mm, and the anaerobic material 58 is preferably a mixture of soil, jutepellet, and iron. The anaerobic material 58 is placed in blocks 61 upon each aerobic layer 62, and in preferred embodiments the blocks 61 are wrapped in jute netting 60 permitting highly controlled positioning and containment of the blocks 61. After placing the blocks 61 in position upon the aerobic layer 62, additional aerobic material 63 is placed between the blocks 61, up to the level of the tops of the blocks 61. Above this anaerobic layer 59, is placed another layer of aerobic material 63, forming a complete aerobic layer 62. Above the aerobic layer 62 is placed another series of anaerobic blocks 61 positioned and spaced such that each anaerobic block 61 is in a position above a corresponding region of aerobic material 63 in the lower anaerobic layer 59. In a subsequent higher layer 62 of aerobic material 63, are placed the aeration manifolds 44 and additional aerobic material 63 is placed thereupon. Further anaerobic layers 59 and aerobic layers 62 are placed into position until the desired number of layers and height of the system is reached. Above the top layer 62 of aerobic material 63 are placed the inlet distribution pipes 26. Above the inlet distribution pipes are layered gravel 56, a plastic net 54, and a layer of masa soil 52. Optionally, the entire system can be sealed with an additional layer of material such as, for example, plastic concrete, gravel, and the like. Each inlet pipe 26 terminates with an inlet vent 29, which rises above the top surface of the system, permitting air, nitrogen, and other gases to escape from the system.

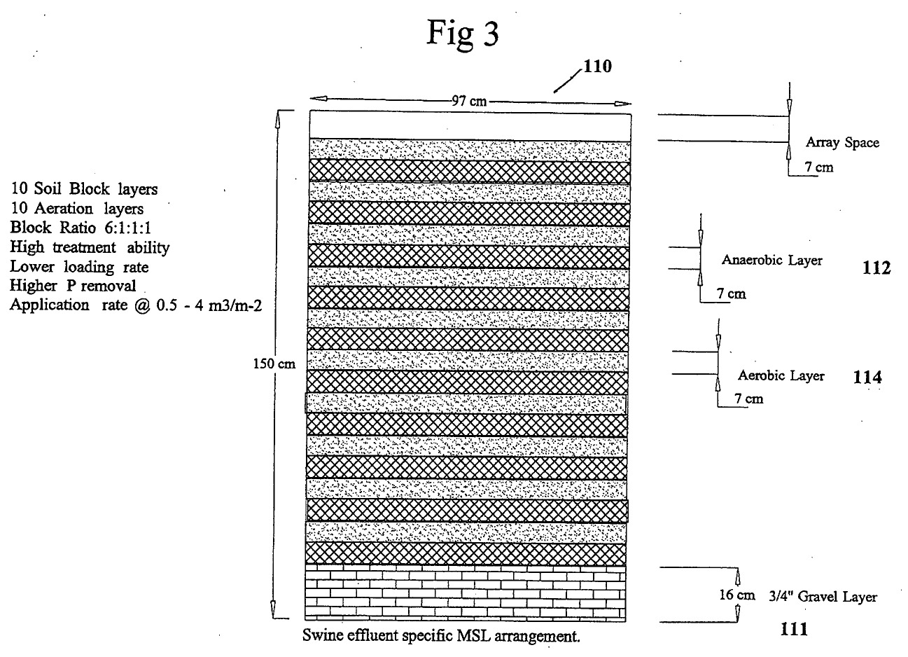

FIG. 3 depicts schematically the layering pattern in dimensions of a swine effluent specific MSL arrangement 110. The arrangement in which a soil block layer 112 is placed upon a deep gravel layer 111 and an aeration layer 114 is placed upon the soil block layer 112. In the system depicted, there are 10 soil block layers 112 and 10 aeration layers 114. The block ratio in this depiction is 6:1:1:1, which indicates a ratio of 6 parts soil, 1 part sawdust, 1 part iron filings, and 1 part charcoal. This system is efficient in the removal of contaminants, thus providing a high treatment ability. The system provides a high loading rate, higher P removal, and supports an application rate of from about 500 to about 4000 liters m⁻² d⁻¹.

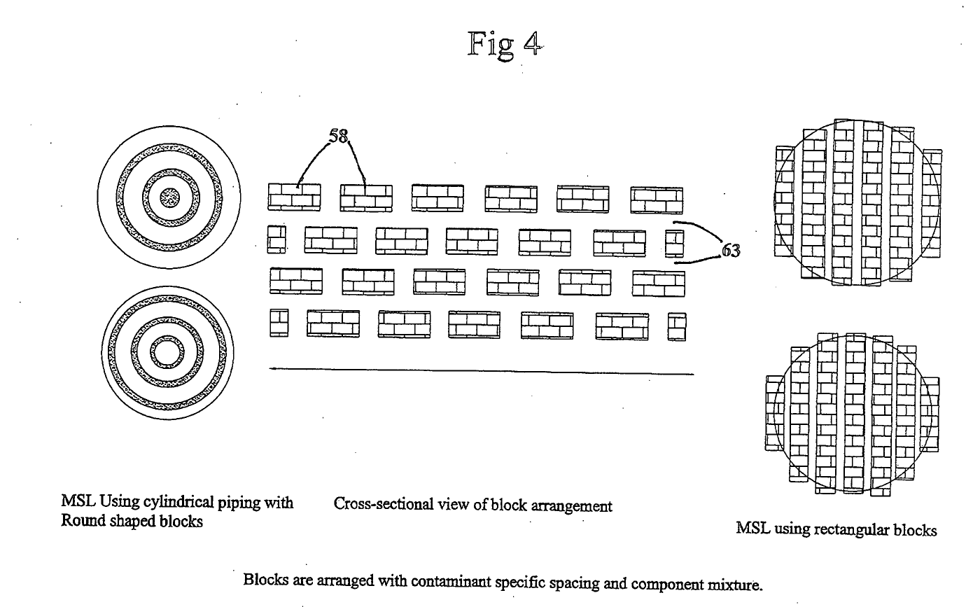

FIG. 4 depicts various arrangements for placement of anaerobic blocks adapted for different configurations of water purification systems. The anaerobic blocks 58 can be placed in concentric rings in a cylindrical piping system. In these rings, in-between each ring is placed an aerobic material 63. Likewise, in a cylinder, the block material can be placed in parallel straight lines, which are staggered from one layer to the next.

In preferred embodiments, the system includes a plurality of soil layers wherein the soil layers are arranged in an alternating pattern of aerobic and anaerobic materials. These materials are typically arranged in a vertical stack, through which water can flow either by pumping or by gravity, essentially straight downward through the stack. As water flows downward through the stack, it encounters an alternating sequence of aerobic layers and anaerobic layers. This alternating sequence results in a series of chemical and biological reactions which have the ability of removing the major contaminants from the feed stream, including, but not limited to, nitrogen, phosphorus, organic wastes, microorganisms, and many particulates.

In preferred embodiments, there is a repetition at least twice of the alternating passage from aerobic to anaerobic to aerobic. Accordingly, in such embodiments, there are at least three aerobic layers with at least two anaerobic layers positioned therebetween. In other embodiments, there are 4, 5, 6, 7, 8, 9, 10, 11, 12, or more anaerobic layers with a corresponding number of aerobic layers. In preferred embodiments, the final layer at the bottom of the arrangement is an aerobic layer. Accordingly, in typical constructions of the system, there is one more aerobic layer than anaerobic layer.

The system typically also includes a piping system for distributing the wastewater to be treated at or near the top layer of soil, and a corresponding system for collecting purified product water at or near the bottom of the stack of soil layers. Likewise, within the stack, in an aerobic layer, is placed a system for air distribution that permits continuous or intermittent delivery of oxygen-containing air or other oxygen-containing gases to the system, to maintain the anaerobic spaces in a properly oxygenated condition. In preferred embodiments, the aerobic layers are continuous and occupy the entire area of the dimensions of the system in each layer. In contrast, in preferred embodiments, the anaerobic layers do not occupy the entire area of the dimensions of the system within a given level. Instead, the anaerobic material occupies a portion of the area within the anaerobic layer, and the remainder of that layer is occupied by aerobic material.

In various embodiments, the ratio between the area occupied by aerobic material and the area occupied by anaerobic material can be adjusted according to the needs of the system including contaminant load, flow rate, and content of nitrogen and carbon in the effluent. In various embodiments, the ratio can be approximately 1:1. Alternatively, the ratio can be, for example, 10:1, 8:1, 6:1, 5:1, 4:1, 3:1, 2:1, 1.5:1, or 1.2:1 in favor of either aerobic material or anaerobic material. Accordingly, as exemplified herein, any ratios can be selected and adapted for the particular conditions to be handled by a given system.

Above the anaerobic layer is positioned another continuous layer of aerobic material above which can be positioned an additional anaerobic layer again, in which regions of anaerobic material are alternated with regions or interspersed with regions of aerobic material. It is desirable, but not essential that the placement of anaerobic material in one layer not be directly above the placement of anaerobic material in the layer below it. This is because there is some benefit to assuring that water flowing essentially directly downward through the system will all pass anaerobic material in at least some of the anaerobic layers.

The positioning of aerobic material within the anaerobic layers, such that such aerobic material is in contact with the aerobic layers, permits a continuous network of aerobic material throughout the height of the stack of layers. This provides the benefit of facilitating the venting of nitrogen gas from the system, the distribution of oxygen throughout the system, and avoids clogging within the system that can arise through accumulation of biofilms. The growth of biofilms is retarded, and biofilms are eventually destroyed or consumed in high oxygen environments. Accordingly, the pervasive distribution of oxygen throughout the system avoids plugging by biofilms and permits rapid regeneration of a working system in such event that in the event that biofilm fouling occurs.

The distribution of oxygen throughout the system thus permits rapid recovery from biofilm blooms and also permits efficient functioning of the aerobic layers. The aerobic layer transforms nitrogen from ammonia to nitrate. The aerobic permeable layer can contain components including but not limited to, for example, perlite, soil, clinoptilolite, other aerobic soil amendments, soil conditioners, natural zeolite, synthetic zeolite, phillipsite, vermiculite, and the like. The aerobic layer can contain mixtures of materials, or can be made of only one material. Accordingly, aerobic material can include any material suitable for passage of water therethrough and for promoting aerobic bacterial growth and aerobic chemical functioning.

The anaerobic layer can contain components that promote the anaerobic condition. Selection of the material for the anaerobic layer can be based on known properties of potential compounds. In some embodiments of the invention, the anaerobic layer transmits very little oxygen, and is therefore relatively dense with low porosity. Accordingly, the layer can contain, for example, one or more components including but not limited to, for example, clay, charcoal, natural soil, peat moss, organic matter, and the like. Preferably, the anaerobic layer has a high level of organic carbon, which serves as an energy source for microorganisms. In some embodiments of the present invention, iron is added to the anaerobic layer to promote removal of phosphorus as described herein.

Throughout this description, reference to soil is intended, in preferred embodiments, to include non-naturally-occurring materials and non-soil materials, as well as natural materials and naturally-occurring soils. Accordingly, any suitable material can be classified in some embodiments as a “soil.” Alternatively, in other embodiments, the term “soil” can refer specifically to naturally-occurring soils; in the case of aerobic soils, this term can refer to any soil harboring an aerobic flora of microorganisms or a flora of microorganisms. Likewise, an anaerobic soil can be any material natural, or non-natural material, which can promote the functioning and growth of anaerobic microorganisms. In some embodiments, anaerobic soil means specifically soils that naturally harbor and/or that can promote the growth and functioning of a flora of anaerobic microorganisms. Anaerobic conditions within the anaerobic material or soil are promoted by materials that can consume oxygen, exclude airflow, and/or promote other functions of the anaerobic layer. Examples of components of an anaerobic layer include, but are not limited to, soil, metal iron, organic matter, and charcoal.

Embodiments of the invention include a method of water purification, wherein water is passed through the layered system as described herein. Water entering the system in these embodiments contains at least one contaminant at a first level and water exiting the system contains a diminished amount of that contaminant. In some embodiments, the contaminant is reduced by 50%. In other embodiments, the contaminant is reduced 2, 3, 4, 5, 10, 20, 50, or 100-fold.

In some embodiments, the contaminant is a heavy metal. Substantial removal of the heavy metal contaminant can occur, for example, by the anaerobic layer. Substantial oxidation of the heavy metal can occur, for example, in the aerobic layer. In some embodiments, the heavy metal contaminant is reduced by 50%. In other embodiments, the heavy metal contaminant is reduced 2, 3, 4, 5, 10, 20, 50, or 100-fold.

A benefit of the simplicity of the soil layering system is that even after the system is depleted, components of the system can be deconstructed and used as fertilizers. Especially valuable are the regions of the system where an iron phosphorus complex has precipitated. Iron and phosphorus are both beneficial soil additives and therefore the aerobic material containing these sequestered components can be used in some cases directly as a fertilizer.

The system can be made for any desired height, width, or other parameters as needed. The system can be placed above ground, or can be below ground, or can be built into an existing slope. The system can be constructed using low cost or recycled materials. The system can be constructed to be suitable for a single home, or can be constructed on a scale suitable for a large factory.

The system can operate at various flow rates, depending on various factors, including, for example, the quality of the wastewater input, the efficiency of the system, the size of the system, the temperature of the system, the number of layers present, the input pumping rate, the drainage pipe width, and the components of the layered material.

The system can operate at a wide range of pH levels. For example, the system can operate with a pH of from about 2.0 or less, 2.5, or 3.0 to about 9.0, or higher. More preferably, the system operates with a pH of from about 3.5, 4.0, 4.5, 5.0, 5.5, or 6.0 to about 6.5, 7.0, 7.5, 8.0, or 8.5. Different micro-areas within the system may have different pH levels. If desired, additives that buffer the pH, or adjust the pH up or down can be added to the system.

The number of layers can vary. For example, the system can have 1, 2, 3, 4, or 5 layers to 20, 30, 40, 50, 100, 250, 500, or 1,000 alternating layers, or more. Similarly, the width and overall volume of each layer can be varied as desired.

Alternatively, one or both of the kinds of layers can be formed into a permeable bag, brick, or similar apparatus, then stacked. These forms can allow the separation of the layers to remain over an extended period.

Each layer may have the same depth, or may differ. One of the layers can be formed into a brick or bag, while the other layer can be loosely layered. The practitioner can determine the best size and shape to utilize for a given system, based on costs, input material, expected life of the system, size of the system, temperature of the environment, and other factors.

The system can operate at a wide range of temperatures. If desired, the system can be artificially heated or cooled to an optimal temperature for optimal wastewater treatment. Preferably, the system operates at a temperature range of about 0C to about 35° C. More preferably, the system operates at a temperature range of about 15° C. to about 30° C.

Many types of microorganisms can be present in the system. For example, a monoculture, methanogenic bacteria, acidogenic bacteria, a mixed population of organisms, or the microorganisms present in the input wastewater material itself can be used. The microorganisms can be a mixture of organisms present in combination with organic material.

Analysis of the System Efficiency

Throughout the specification, several wastewater treatment terms are used. The term “TCOD” (Total Chemical Oxygen Demand) is a measure of the total organic pollutant present. The term “COD removal” describes the Chemical Oxygen Demand removed from the system. The term “SCOD” (soluble chemical oxygen demand) is a measure of the amount of the soluble fraction of the TCOD.

The COD removal efficiency can vary depending on the wastewater type, concentration, flow rates, and other factors. For example, in some embodiments of the invention, the COD removal can be between about 10% or less, 20%, or 30% to about 55%, 60%, 70%, 80%, or greater at a loading rate of over about 10 g/l/d.

Wastewater can be characterized according to Oxygen Demand. Oxygen Demand is a characterization of how much oxygen is needed to effectively treat the oxidizable constituents in the wastewater to make them environmentally benign. Oxygen Demand is usually divided into two constituents, namely Biological Oxygen Demand (BOD) and Chemical Oxygen Demand (COD). COD is commonly measured by the so-called Hach Method 8000. For wastewater systems associated with habitations, BOD is the commonly used parameter. BOD is typically measured according to United States Environmental Protection Agency Standards.

Removal of Contaminants

The term “coliform” as used herein, generally refers to a type of bacteria. The presence of coliform-type bacteria is an indication of possible pathogenic bacterial contamination. The term “fecal coliforms” generally refers to those coliforms found in the feces of various warm-blooded animals, whereas the term coliform also includes other environmental sources. Measurements of fecal coliforms are typically performed by standard tests to indicate contamination from sewage or level of disinfection. Fecal coliform is generally measured as colonies/100 mL.

The method of the present invention can be used to remove fecal contamination of the input material, including, for example, fecal-derived organisms such as fecal coliform, total coliform, fecal streptococci, enterococci, and Escherichia coli. Non-fecal microbial contaminants that can be removed by the system of the invention include, for example, Staphylococcus species, Pseudomonas sp., and Aeromonas sp. Other types of common biological contaminants present in bodies of water are described, for example, in Wade et al. (2003), Environmental Health Perspectives, 111:1102-1109, which is incorporated herein by reference in its entirety.

Livestock waste may also contain many types of dangerous pathogens that can be transmitted to humans. Examples of common livestock-derived fecal pathogens that can be transmitted from livestock to people include enteric bacteria such as Salmonella and Shigella and protozoa such as Cryptosporidium and Giardia. In some embodiments, the method of the invention can also be used to remove or reduce viral contamination, fungal contamination, or other organisms.

The method of the invention can also remove contaminants such as “endocrine disruptors”, “endocrine mimics”, and “hormonally active agents” (HAA) from contaminated sources. For more information on HAAs as environmental contaminants see NRC (National Academy of Science), 1999. Hormonally Active Agents in the Environment. National Research Council, Board on Environmental Studies and Toxicology, Commission on Life Sciences. National Academy Press, Washington, D.C., which is incorporated herein by reference in its entirety.

In additional embodiments of the present invention, the system can be used to remove estrogen-like contaminating materials. A description of Estrogen-like contaminants can be found, for example, in Kristensen, P., 1997. Estrogen-like substances: Use, occurrence effects on humans and the environment. Center for Integrated Environment and Toxicology, Hørsholm, Denmark, which is incorporated by reference in its entirety.

Other contaminants that can be removed include, for example, plant growth regulators, pesticides, antibiotics, heavy metals, organometallic contaminants, agrochemicals, and the like.

The waste to be treated can be derived from a number of sources. Examples include dairy waste, agricultural effluent, pond, crop effluent, sewage facility, slough, waste from crop plants, greenhouse waste, drainage from industrial facilities, aquaculture waste, food production waste, overflow runoff, and the like.

What is claimed is:

1. A water purification system comprising a plurality of soil layers, wherein the plurality comprises at least two aerobic soil layers with an anaerobic soil layer positioned therebetween, wherein at least a portion of water passing through the system passes in sequence from an aerobic layer, to an anaerobic layer, then to another aerobic layer, the system further comprising a water inlet, a water outlet, and an air distributor in at least one soil layer.

2. The system of claim 1, comprising at least two each of aerobic layers and anaerobic layers in an alternating order.

3. The system of claim 1, wherein the soil layers are positioned substantially horizontally, such that at least one anaerobic layer has an aerobic layer above it and an aerobic layer beneath it.

4. The system of claim 3, having at least about 6 aerobic layers and at least about 5 anaerobic layers.

5. The system of claim 1, wherein the air distributor comprises an aeration pipe positioned in an aerobic soil layer.

6. The system of claim 5, wherein the aeration pipe is positioned in a layer that is closer to a lower boundary of the system than to an upper boundary of the system.

7. The system of claim 1, wherein the anaerobic layer comprises anaerobic soil material with portions of aerobic soil material positioned therein, such that the system comprises a substantially continuous aerobic pathway through the plurality of soil layers.

8. The system of claim 7, wherein the aerobic pathway is not linear.

9. The system of claim 1, wherein the aerobic layer comprises at least one component selected from the group consisting of zeolite, perlite, and soil.

10. The system of claim 1, wherein the anaerobic layer comprises at least one component selected from the group consisting of soil, metal iron, organic matter, and charcoal.

11. A method of water purification comprising:
providing a layered soil system comprising a series of alternating aerobic and anaerobic soil layers, the system further comprising an air distributor, a water inlet and a water outlet;
introducing contaminated water at the inlet, wherein the contaminated water comprises a first amount of at least one contaminant;
aerating the system by introducing a gas comprising oxygen into the air distributor; and
recovering purified water from the outlet, wherein the purified water comprises a second amount of the at least one contaminant, and wherein the second amount is lower than the first amount.

12. The method of claim 11, wherein the contaminated water comprises at least one contaminant selected from the group consisting of: biological oxygen demand organic matter, chemical oxygen demand organic matter, nitrogen, phosphorus, a microorganism, an endocrine disrupter, a pesticide, a hormone, and a heavy metal.

13. The method of claim 12, wherein the microorganism is a fecal coliform bacterium.

14. The method of claim 11, wherein the contaminated water was is from a source selected from the group consisting of: an animal facility, a municipality, a building, a river, a lake, dairy waste, agricultural effluent, pond, crop effluent, sewage facility, slough, waste from crop plants, drainage from industrial facilities, aquaculture waste, food production waste, and overflow runoff.

15. A method of assembling a water purification system comprising the steps of:
positioning a plurality of soil layers to form a stack of alternating aerobic and anaerobic soil layers;
providing a water inlet capable of directing water to or above an upper layer;
and
providing a water outlet capable of carrying water from or below a lower layer.

16. The method of claim 15, further comprising:
providing an air distributor in at least one layer.

17. The method of claim 16, wherein the air distributor comprises an aeration pipe having a plurality of holes therein.

18. The method of claim 15, wherein the positioning step comprises placing layers of anaerobic material wherein, in each layer, the anaerobic material is interrupted with regions of aerobic material such that the assembled system comprises a continuous vertical pathway of aerobic material, the pathway comprising the aerobic layers in contact with aerobic portions positioned within the anaerobic layers.

19. The method of claim 18, wherein the vertical aerobic pathway is not linear.

20. The method of claim 15, wherein the positioning step comprises positioning at least about 6 aerobic layers and at least about 5 anaerobic layers.
